(19) United States
(12) Patent Application Publication
(10) Pub. No.: US 2020/0180793 A1
(43) Pub. Date: Jun. 11, 2020

(54) industrial perfume quantitative filling machine in factory

(71) Applicant: Ming Wang, Fuzhou City (CN)

(72) Inventor: Ming Wang, Fuzhou City (CN)

(21) Appl. No.: 16/792,868

(22) Filed: Feb. 17, 2020

(30) Foreign Application Priority Data
Oct. 30, 2019 (CN) 201910435360

(51) Int. Cl. B65B 1/06; B65B 1/46; B65B 43/54

(52) U.S. Cl. CPC B65B 1/06; C11D 3/505; B65B 43/54; B65B 1/46

(57) ABSTRACT

The invention discloses an industrial perfume quantitative charging machine in a factory. A casing is provided with a working cavity therein. A charging component is provided on an inner wall at the rear side of the working cavity. The charging component includes a fixed component. The spice box on the inner wall of the rear side of the working chamber, the spice chamber provided in the spice box, a conduit connected between the spice chamber and the working chamber, and slidingly connected to the inner wall of the back side of the working chamber Loading slider. The present invention uses a charging slider to effectively control the communication between the fragrance cavity and the container. Using components such as electromagnets and left-right symmetrical ratchet teeth, it can peel skinned containers of different weights and ensure industrial spices.

### CROSS-REFERENCES TO RELATED APPLICATIONS

The present application claims priority from Chinese application No. 2019110435360 filed on Oct. 30, 2019 which is hereby incorporated by reference in its entirety.

### TECHNICAL FIELD

The present invention relates to the field of quantitative feeding, in particular to an industrial perfume quantitative filling machine in factory.

### BACKGROUND OF THE INVENTION

Industrial perfume has a rough fragrance, high temperature resistance and long-lasting fragrance. It is mainly used in plastic rubber, chemical coatings and paints and inks to cover up the odor and increase the fragrance to achieve the best selling point. Quantitative filling is carried out in advance, but the weight of the containers containing industrial spices is different, which leads to the occurrence of insufficient or excessive weight when the industrial spices are contained, which will affect the use effect of industrial spices. Device for solving the above problems.

### BRIEF SUMMARY OF THE INVENTION

### Technical Problem

The weight of the containers containing industrial flavors varies, and as a result, when the industrial flavors are contained, the weight may be insufficient or excessive.

In order to solve the above-mentioned problem, an industrial perfume quantitative charging machine in a factory is designed in this example, which includes a casing, a working cavity is arranged in the casing, and a charging component is arranged on the inner wall at the rear side of the working cavity. The material assembly includes a spice box fixed on the inner wall on the rear side of the working cavity, a spice cavity provided in the spice box, a conduit connected between the spice cavity and the working cavity, and slidingly connected to the A charging slider on the inner wall at the rear side of the working cavity, and the toothless portion of the charging slider can extend radially into the duct. A replacement chute is provided on the inner wall at the rear side of the working cavity. The rear inner wall is provided with a charging chute, and the replacement chute and the charging chute are provided with a peeling component, and the peeling component includes a replacement slider slidingly connected to the replacement chute, A replacement bracket fixed on the upper end of the replacement slider, an electromagnet fixed on the right end of the replacement bracket, a charging slider slidingly connected to the charging chute, and a fixed loading slider The upper loading bracket and the connecting bracket fixed on the upper end of the loading bracket are fixed on the A disc connected to the upper end of the bracket, a container slidably connected to the disc, an iron block fixed to the left end of the loading bracket, and a T symmetrically arranged left and right on the left end of the replacement bracket and the right end of the loading bracket A profile rod, a fixed ratchet fixed on the T-bar and away from the central axis, a left-right symmetrical hinge ratchet that is hinged to the inner wall of the front side of the working cavity, is connected to the hinge ratchet and the work A ratchet spring between the left and right inner walls of the cavity, an abutting concave rod hinged to the inner wall of the front side of the working cavity, and a sliding connection to the inner wall of the front side of the working cavity, and can be connected to the abutment block, on the replacement bracket A container replacement assembly is provided that can automatically replace the container.

Preferably, the outlet of the lower end of the conduit is directly facing the container, which is beneficial for the container to receive the fragrance. The left inner wall of the working cavity and the right inner wall of the working cavity are communicated with each other through left and right symmetrical through holes. And the abutting concave rod extends to the outside through an adjustment through hole, an adjustment cavity is provided in the adjustment through hole, and a conveyance located on the right side of the adjustment cavity on the right side of the working cavity is provided. A transport plate for sliding the container is slidably connected to the inner wall of the rear side of the working cavity, and the transport plate extends to the outside through the conveying port, and a horizontal block is fixed on the rear wall of the working cavity, A resetting spring is connected between the horizontal block and the transport plate, a fixed block is fixed on the upper inner wall of the adjustment cavity, and a right inner wall of the working cavity communicates with the outside and a connection port is provided.

Preferably, a vertical support plate is fixed at the upper end of the replacement support, a horizontal support plate is fixed at the upper end of the vertical support plate, a vertical support is fixed at the upper end of the horizontal support plate, and the rear side of the working cavity A container inlet is provided on the inner wall in communication with the outside, and a container slideway extending outward through the container inlet is fixed on the inner wall on the rear side of the working cavity.

Wherein, the charging assembly further includes a stepping motor embedded in the inner wall of the upper side of the working cavity, a driving shaft is dynamically connected to the lower end of the stepping motor, and the driving shaft is fixedly connected with the charging The toothed part of the slider meshes with the loading gear.

Wherein, the peeling component further includes a connection spring connected to the connection between the abutment block and the fixing block, and the lower end of the transport plate is fixedly located outside the right end of the working cavity and can be abutted with the abutment. A main abutting rod abutted by a concave rod, a lower end of the transport plate is fixed with a main adjusting rod located in the working cavity and abutting with the abutting block on the right side, and a left end of the main adjusting rod is fixedly provided A connecting rod extending to the outside through the connecting port, a lower end of the connecting rod is fixedly provided with a secondary abutting rod located outside and capable of abutting the abutting concave rod, and a lower end of the connecting rod is fixedly provided at the The auxiliary adjusting rod in the working cavity and can be in contact with the abutting block.

Wherein, the container replacement assembly includes a horizontal bracket fixed to the left end of the connection bracket, the horizontal bracket is embedded with a motor, the lower end of the motor is dynamically connected to a motor shaft, and the first end of the lower end of the motor shaft is fixed with a first A coupling, a main gear shaft is rotatably connected to the replacement bracket, and a second coupling which can be cooperatively connected with the first coupling is fixed at the upper end of the main gear shaft, and the main gear shaft A main gear located below the second coupling is fixedly fixed, and a replacement gear shaft located on the left side of the main gear shaft is rotatably connected to the replacement bracket. The auxiliary gear meshed with the main gear, a main pulley is fixed at the upper end of the auxiliary gear shaft, a auxiliary pulley shaft is rotatably connected to the horizontal support plate, and an auxiliary pulley is fixed on the auxiliary pulley shaft. A belt is connected between the auxiliary pulley and the main pulley. A matching gear located on the upper side of the auxiliary pulley is fixed on the auxiliary pulley shaft, and the matching is fixed on the auxiliary pulley shaft. A sector gear on the upper side of the gear that can be meshed with the disc, and The teeth on the sector gear are symmetrical ninety degree teeth, a replacement rack is slidably connected to the vertical bracket, and the tooth surface of the replacement rack can be meshed with the sector gear, and the replacement tooth A spring is connected between the bar and the left inner wall of the working cavity, and a semi-circular swivel that can be meshed with the mating gear is rotatably connected to the disc. The semi-circular swivel is semi-circular.

The beneficial effect of the present invention is that the present invention uses a charging slider to effectively control the communication between the fragrance cavity and the container, and uses components such as electromagnets and left-right symmetrical ratchet teeth to realize peeling of containers of different weights, which ensures that The quality of industrial spices is accurate. Components such as semi-circular rings and replacement racks are used to automatically replace the container. This improves the weight of containers containing industrial spices, which leads to insufficient weight or excessive weight.

### BRIEF DESCRIPTION OF THE DRAWINGS

For ease of explanation, the present invention is described in detail by the following specific embodiments and the accompanying drawings.

FIG. 1 is a schematic diagram of the overall structure of an industrial perfume quantitative charging machine in a factory of the present invention;

FIG. 2 is a schematic structural diagram of the direction “A-A” of FIG. 1;

FIG. 3 is a schematic structural diagram of the “B-B” direction of FIG. 1;

FIG. 4 is a schematic enlarged view of the structure of “C” in FIG. 1.

### DETAILED DESCRIPTION OF THE INVENTION

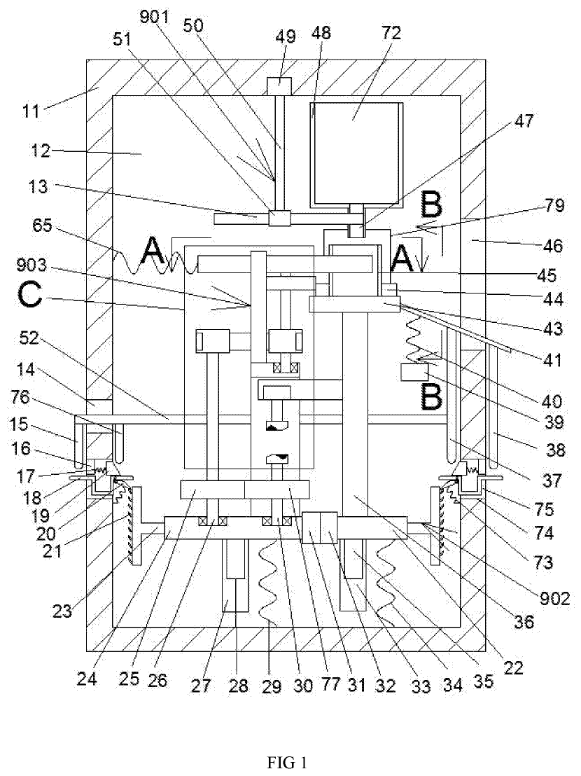

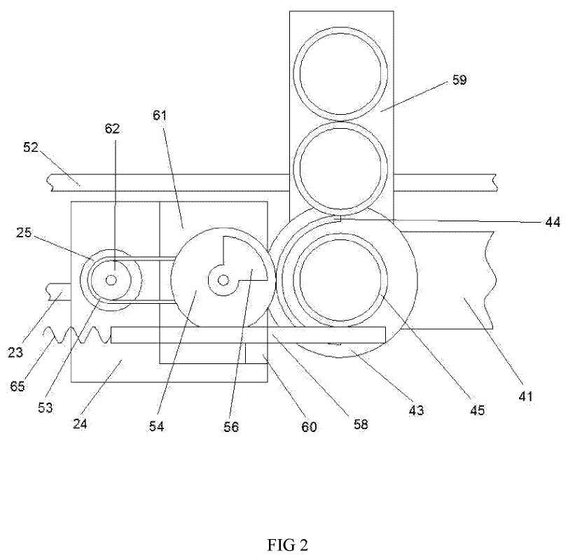

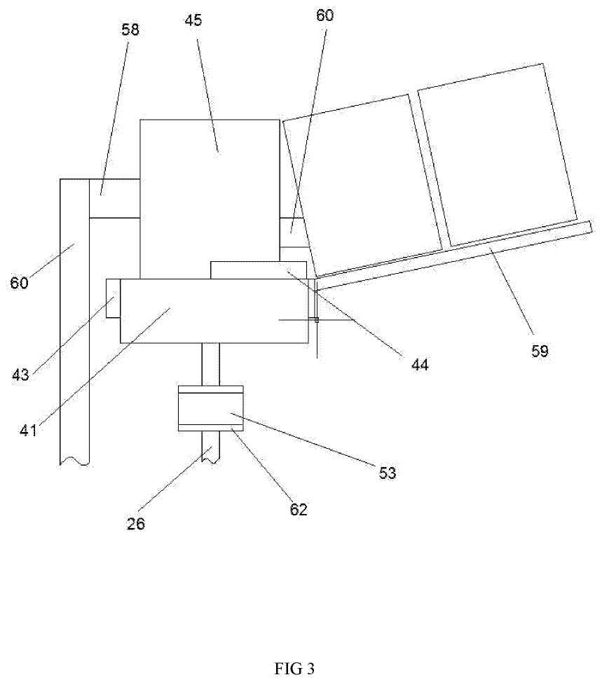

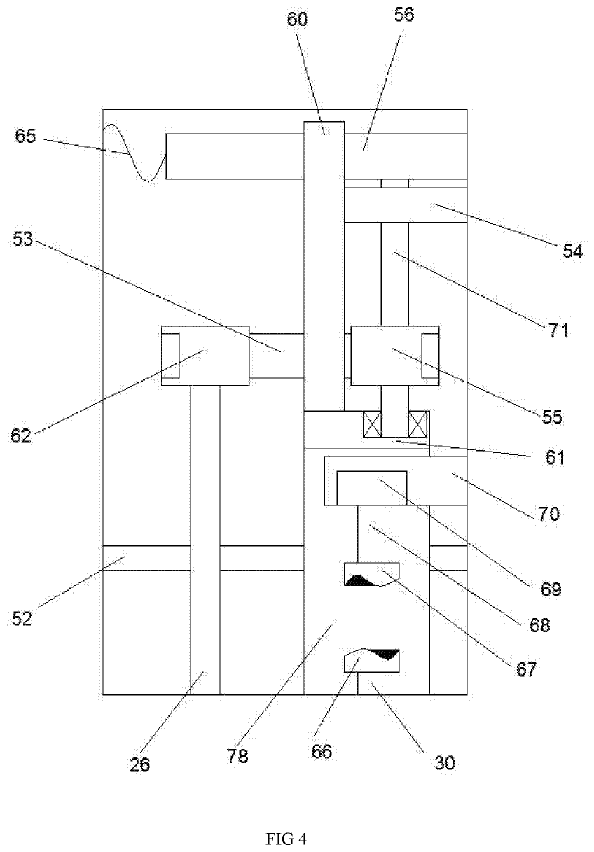

The present invention will be described in detail below with reference to FIGS. 1-4. For convenience of description, the orientation described below is defined as follows: the up-down, left-right, and front-back directions described below are consistent with the up-down, left-right, and front-back directions of the projection relationship of FIG. 1 itself.

The invention relates to an industrial perfume quantitative filling machine in a factory, which is mainly used in the process of quantitative charging. The invention will be further described below with reference to the accompanying drawings of the invention:

The industrial perfume quantitative charging machine in the factory according to the present invention includes a casing 11, and a working chamber 12 is provided in the casing 11. A charging component 901 is provided on the inner wall of the rear side of the working chamber 12. The charging assembly 901 includes a spice box 48 fixed on the inner wall of the rear side of the working chamber 12, a spice chamber 72 provided in the spice box 48, and connected to the spice chamber 72 and the working chamber 12. Between the guide tubes 47, which are slidingly connected to the loading slider 13 on the inner wall of the rear side of the working chamber 12, and the non-teeth portion of the loading slider 13 can extend radially into the guide tube 47 to control the charging Function, a replacement chute 27 is provided on the inner wall on the rear side of the working chamber 12, a charging chute 33 is provided on the inner wall on the rear side of the working chamber 12, and the replacement chute 27 and the charging chute 33 are provided A peeling component 902 is provided. The peeling component 902 includes a replacement slider 28 slidably connected to the replacement chute 27, and a replacement bracket 24 fixed to the upper end of the replacement slider 28. Replace the electromagnet 31 at the right end of the bracket 24, the loading slider 35 slidably connected to the loading chute 33, and the Material holder 22, a connection bracket 36 fixed on the upper end of the loading bracket 22, a disk 43 fixed on the upper end of the connection bracket 36, a container 45 slidably connected to the disk 43, and fixed on The iron block 32 at the left end of the loading bracket 22, the T-shaped rod 23 symmetrically provided on the left end of the replacement bracket 24 and the right end of the loading bracket 22 symmetrically, and fixed on the T-shaped rod 23 and away from the central axis Fixed ratchet 21 at the place, a left-right symmetrical hinge ratchet 20 hinged to the front inner wall of the working cavity 12, a ratchet spring 73 connected between the hinge ratchet 20 and the left and right inner walls of the working cavity 12, The abutting concave rod 18 hinged with the inner wall of the front side of the working cavity 12 is slidably connected with the inner wall of the front side of the working cavity 12 and can be connected with the abutting block 19 when the container 45 is placed on the disc At 43, when the electromagnet 31 is energized, it drives the iron block 32 to move downward together. When the left and right symmetrical ratchet teeth 21 move downward, the upward movement of the articulated ratchet teeth 20 is restricted to realize the peeling function. A container replacement assembly 903 is provided on the replacement bracket 24 to automatically replace the container 45.

Beneficially, the outlet of the lower end of the conduit 47 is directly opposite to the container 45, which facilitates the reception of spices by the container 45. The left inner wall of the working cavity 12 and the right inner wall of the working cavity 12 are communicated with each other with a left-right symmetry. Adjusting through hole 74, and the abutting concave rod 18 extends to the outside through the adjusting through hole 74, the adjusting through hole 74 is provided with an adjusting cavity 75, and the inner wall of the right side of the working cavity 12 is provided with the A transporting port 46 on the upper side of the regulating cavity 75 on the right side, and a transport plate 41 for sliding the container 45 is slidably connected to the inner wall of the rear side of the working chamber 12, and the transporting plate 41 passes through the transporting port 46. Extending to the outside, a horizontal block 39 is fixed on the rear wall of the working cavity 12, a return spring 40 is connected between the horizontal block 39 and the transport plate 41, and an upper inner wall of the adjusting cavity 75 is fixed. The fixing block 16 is provided with a connection port 14 on the right inner wall of the working cavity 12 communicating with the outside.

Beneficially, a vertical support plate 78 is fixed on the upper end of the replacement bracket 24, and a horizontal support plate 61 is fixed on the upper end of the vertical support plate 78. A vertical support 60 is fixed on the upper end of the horizontal support plate 61. A container inlet 79 is provided on the inner wall of the rear side of the working chamber 12 and communicates with the outside. A container slide 59 extending outward through the container inlet 79 is fixed on the inner wall of the rear side of the working chamber 12. The container slide 59 The empty container 45 can be placed thereon, and the container 45 on the container slide 59 can be moved to the disc 43 by gravity.

According to the embodiment, the charging assembly 901 is described in detail below. The charging assembly 901 further includes a stepping motor 49 embedded in the inner wall of the upper side of the working chamber 12, and the lower end of the stepping motor 49 is connected with power. A driving shaft 50 is provided with a loading gear 51 fixedly engaged with the toothed portion of the loading slider 13. The rotation of the loading gear 51 drives the loading slider 13 The toothed part moves left and right inside the duct 47, so as to realize the charging function.

According to the embodiment, the peeling component 902 is described in detail below. The peeling component 902 further includes a connecting spring 17 connected between the abutment block 19 and the fixing block 16, and a lower end of the transport plate 41. A main abutting rod 38 is fixedly located outside the right end of the working cavity 12 and can be abutted with the abutting concave rod 18, and a lower end of the transport plate 41 is fixedly located in the working cavity 12 and can be connected with the right A main adjusting rod 37 abutted by the abutting block 19 is fixed on the left end of the main adjusting rod 37 with a connecting rod 52 extending to the outside through the connecting port 14, and a lower end of the connecting rod 52 is fixed on the outside. A secondary abutment rod 15 capable of abutting the abutting concave rod 18 is fixed at the lower end of the connecting rod 52 to a secondary adjustment provided in the working cavity 12 and capable of abutting the abutting block 19. The lever 76, when the container 45 falls on the transport plate 41, the transport plate 41 slides down, driving the main adjustment lever 37 to abut against the abutting block 19 on the right side, and driving the right side The abutment block 19 moves to the right, and at this time, the abutment block 19 on the right side is no longer in abutment with the right abutment concave rod 18, and at the same time, the main adjustment lever 37 drives the The main abutment rod 38 moves downward to abut against the right-side abutting concave rod 18, so that the right-side hinge ratchet 20 is no longer fixed to the right side under the elastic force of the loading spring 34. The ratchet 21 is limited, and the main adjusting lever 37 drives the auxiliary adjusting lever 76 to contact the abutment block 19 on the left side through the connecting rod 52. At this time, the abutment block 19 on the left side is no longer It is in contact with the left abutment recessed rod 18, and the connecting rod 52 drives the auxiliary abutment rod 15 to move downward to abut the left abutment recessed rod 18, so that in the Under the action of the elastic force, the left-side articulated ratchet teeth 20 no longer limit the left-side fixed ratchet teeth 21, and the peeling device is reset.

According to an embodiment, the container replacement assembly 903 is described in detail below. The container replacement assembly 903 includes a horizontal bracket 70 fixed to the left end of the connection bracket 36. The horizontal bracket 70 has a motor 69 embedded therein, and the motor 69 A motor shaft 68 is dynamically connected at the lower end, and a first coupling 67 is fixed at the lower end of the motor shaft 68. A main gear shaft 30 is rotatably connected to the replacement bracket 24, and an upper end of the main gear shaft 30 is fixed. There is a second coupling 66 that can be cooperatively connected with the first coupling 67. The main gear shaft 30 is fixed with a main gear 77 located below the second coupling 66. The replacement The bracket 24 is rotatably connected with a sub-gear shaft 26 located on the left side of the main gear shaft 30. The sub-gear shaft 26 is fixed with a sub-gear 25 meshed with the main gear 77. A main pulley 62 is fixed at the upper end, and a secondary pulley shaft 71 is rotatably connected to the horizontal support plate 61. A secondary pulley 55 is fixed to the secondary pulley shaft 71. The secondary pulley 55 is connected to the main pulley. A belt 53 is connected between the pulleys 62, and the auxiliary pulley shaft 71 is fixed with an upper side of the auxiliary pulley 55. The mating gear 54 is fixed on the auxiliary pulley shaft 71 with a sector gear 56 located on the upper side of the mating gear 54 and meshingly connected with the disc 43. The teeth on the sector gear 56 are symmetrical nine. Ten-degree tooth, the vertical rack 60 is slidably connected with a replacement rack 58, and the toothed surface of the replacement rack 58 can be meshed with the sector gear 56, and the replacement rack 58 and the working cavity 12 A spring spring 65 is connected between the left inner wall and the disc 43 is rotatably connected with a semicircular swivel 44 that can be meshed with the mating gear 54. The semicircular swivel 44 is semicircular and the semicircular The ring 44 may abut the empty container 45.

The following is a detailed description of the use steps of an industrial perfume dosing machine in a factory in conjunction with FIGS. 1 to 4:

Initial state: the first coupling 67 and the second coupling 66 are not cooperatively connected, the replacement bracket 24 is at the uppermost position, the loading bracket 22 is at the uppermost position, and the main adjustment lever 37 is not in contact with the right abutment block 19, The main contact lever 38 is not in contact with the right contact recessed rod 18, the right contact block 19 is in contact with the right contact recessed rod 18, and the auxiliary adjustment lever 76 is in contact with the left contact block 19, the secondary contact The connecting rod 15 is in contact with the left contact recessed rod 18, and the left contact block 19 is in contact with the left contact recessed rod 18.

During operation, the electromagnet 31 is energized, and an empty container 45 is placed on the disc 43. The disc 43 moves downwards, so that the loading bracket 22 is driven downward by the connecting bracket 36, and the loading bracket 22 drives the left side T The profile bar 23 and the left fixed ratchet 21 move downwards. At this time, the right hinged ratchet 20 plays a limiting role. At the same time, the loading bracket 22 drives the electromagnet 31 attracted by the iron block 32 through the electromagnet 31 to move downward. The electromagnet 31 that moves down moves the left fixed ratchet 21 downward by replacing the bracket 24 and the left T-bar 23 in order. At this time, the left hinge ratchet 20 plays a limiting role and realizes the peeling function. In the process, the replacement of the spring 29 and the loading spring 34 accumulates the elastic potential energy. At this time, the electromagnet 31 is powered off, the stepping motor 49 is started, and the driving shaft 50 is rotated. The rotating driving shaft 50 drives the loading through the loading gear 51 The material slider 13 moves to the left until the charging slider 13 is completely in the working chamber 12 and the stepping motor 49 is suspended. At this time, 42 accumulates the elastic potential energy and connects the fragrance chamber 72 with the container 45. The fragrance enters the container 45 through the tube 47, and the disc 43 is in the container 45 The increase in the weight of the perfume continues to move downward, and the fashion spring 34 continues to accumulate elastic potential energy, so the horizontal bracket 70, the motor 69, the motor shaft 68, and the first coupling 67 on the disc 43 also move downward until the first When the coupling 67 and the second coupling 66 are cooperatively connected, the stepping motor 49 rotates in the reverse direction, causing the driving shaft 50 to rotate in the reverse direction, and the driving shaft 50 in the reverse rotation drives the loading slide 13 through the loading gear 51. Move to the right until the fragrance cavity 72 is not connected to the container 45. At this time, the motor 69 is started to rotate the motor shaft 68. The rotated motor shaft 68 is driven by the first coupling 67, the second coupling 66, and the main gear shaft 30 in this order. The main gear 77 rotates, and the rotation of the main gear 77 drives the auxiliary pulley shaft 71 to rotate through the auxiliary gear shaft 26, the main pulley 62, the belt 53, and the auxiliary pulley 55. The rotation of the auxiliary pulley shaft 71 drives the cooperation gear 54 to rotate, and the cooperation gear 54 The rotation of the semi-circular rotating ring 44 drives the rotation of the semi-circular ring 44 in the process. The rotation of the auxiliary pulley shaft 71 drives the sector gear 56 to rotate. When the sector gear 56 is meshed with the replacement rack 58, the replacement rack 58 is moved to the right, and the spring 65 accumulates. Elastic potential energy, replace rack 58 by friction The force drives the container 45 to the right and enters the transport plate 41. At the same time, the container 45 on the container slide 59 slides down to the disc 43 due to gravity. The fashion spring 34 and the replacement spring 29 release the elastic potential energy and drive the replacement bracket 24. The loading bracket 22 moves upwards. At this time, the second coupling 66 and the first coupling 67 are no longer cooperatively connected. The spring 65 releases the elastic potential energy, which drives the replacement of the rack 58 to reset. The electromagnet 31 is re-energized and connected with the iron block. 32 is closely attracted. As the semi-circular swivel 44 continues to rotate, the first container 45 is separated from the adjacent container 45. Finally, the semi-circular swivel 44 rotates a circle. When the container 45 containing the spices falls on the transport plate 41, it is transported. The plate 41 slides downward, and the return spring 40 accumulates elastic potential energy, drives the main adjustment lever 37 to abut against the right contact block 19, and drives the right contact block 19 to move to the right, and the right connection spring 17 accumulates elastic potential energy. When the right contact block 19 is no longer in contact with the right contact recessed rod 18, the main adjustment lever 37 drives the main contact rod 38 to move downward to abut the right contact recessed rod 18, thereby loading the spring The elastic force of 34 makes the right hinge ratchet 20 no longer on the right Fix the ratchet 21 limit, meanwhile, the main adjustment lever 37 drives the auxiliary adjustment lever 76 to contact the left contact block 19 through the connecting rod 52, the left contact block 19 moves to the left, and the left connection spring 17 accumulates elastic potential energy. At this time, the left contact block 19 is no longer in contact with the left contact recessed rod 18, and the connecting rod 52 drives the auxiliary contact rod 15 to move downward to abut the left contact recessed rod 18, thereby replacing the spring 29 Under the action of the elastic force, the left hinge ratchet 20 no longer limits the left fixed ratchet 21, at this time, the return spring 40 releases the elastic potential energy, which drives the transport plate 41 to move upward, and the right connection spring 17 releases the elastic potential energy, which drives the right 19 is reset, and the left connecting spring 17 releases the elastic potential energy, which drives the left 19 to reset. At this time, the container 45 for fragrance is finally slid to the external device through the delivery port 46 to restore the initial state, which is convenient for the next loading work.

The beneficial effect of the present invention is that the present invention uses a charging slider to effectively control the communication between the fragrance cavity and the container, and uses components such as electromagnets and left-right symmetrical ratchet teeth to realize peeling of containers of different weights, which ensures that The quality of industrial spices is accurate. Components such as semi-circular rings and replacement racks are used to automatically replace the container. This improves the weight of containers containing industrial spices, which leads to insufficient weight or excessive weight. Status quo.

In the above manner, those skilled in the art can make various changes according to the working mode within the scope of the present invention.

1. An industrial perfume quantitative filling machine in a factory includes a casing, and the casing is provided with a working cavity;
A charging component is provided on the inner wall at the rear side of the working cavity, and the charging component includes a spice box fixed on the inner wall at the rear side of the working cavity, a spice cavity provided in the spice box, and connected to the The guide tube between the fragrance chamber and the working chamber is slidingly connected to a charging slider on the inner wall at the rear side of the working chamber, and the toothless portion of the charging slider can extend radially into the guide tube. The inner wall of the rear side of the working chamber is provided with a replacement chute, and the inner wall of the rear side of the working chamber is provided with a charging chute;
A peeling component is provided on the replacement chute and the charging chute, and the peeling component includes a replacement slider slidingly connected to the replacement chute, and a replacement fixed on the upper end of the replacement slider. A bracket, an electromagnet fixed to the right end of the replacement bracket, a loading slider slidingly connected to the loading chute, a loading bracket fixed to the upper end of the loading slider, and fixed to the bracket A connecting bracket at the upper end of the loading bracket, a disk fixed on the upper end of the connecting bracket, a container slidably connected to the disk, an iron block fixed on the left end of the loading bracket, and left and right symmetrically arranged in the place. The T-shaped rod at the left end of the replacement bracket and the right end of the loading bracket, fixed ratchet teeth fixed on the T-shaped rod and away from the central axis, and left-right symmetrical hinged ratchets that are hinged to the inner wall of the front side of the working cavity. Teeth, a ratchet spring connected between the articulated ratchet and the left and right inner walls of the working cavity, an abutting concave rod hinged to the front inner wall of the working cavity, and slidingly connected to the front inner wall of the working cavity, and can be With the abutment block, the replacement bracket is provided with an automatic replacement station. Container assembly container replacement.

2. The industrial perfume dosing machine in claim 1, wherein the outlet of the lower end of the duct is directly facing the container, which is beneficial for the container to receive spices, and the left inner wall of the working cavity A left-right symmetrical adjustment through-hole is communicated with the inner wall on the right side of the working cavity, and the abutting concave rod extends to the outside through the adjustment through-hole. The adjustment through-hole is provided with an adjustment cavity. The side inner wall is provided with a conveying port located on the upper side of the regulating cavity on the right side, and the inner wall on the rear side of the working cavity is slidably connected with a transport plate for sliding the container, and the transport plate passes the transport The mouth extends to the outside, a horizontal block is fixed on the back wall of the working cavity, a return spring is connected between the horizontal block and the transport plate, and a fixing block is fixed on the inner wall on the upper side of the adjusting cavity. A connection port is provided on the right inner wall of the working cavity to communicate with the outside.

3. The industrial perfume quantitative charging machine according to claim 1, characterized in that: a vertical support plate is fixed on the upper end of the replacement support, and a horizontal support plate is fixed on the upper end of the vertical support plate, so A vertical bracket is fixed at the upper end of the horizontal support plate, and a container inlet is provided on the inner wall of the back side of the working cavity, which communicates with the outside. A container slide extending outward through the container inlet is fixed on the inner wall of the back side of the working cavity. Road.

4. The industrial perfume dosing machine of claim 1, wherein the charging assembly further comprises a stepping motor embedded in an inner wall on the upper side of the working chamber, and the stepping motor A drive shaft is dynamically connected at the lower end, and a loading gear fixedly meshed with the toothed portion of the loading slider is fixed on the driving shaft.

5. The industrial perfume dosing machine according to claim 1, wherein the peeling component further comprises a connection spring connected to a connection between the abutment block and the fixing block, and The lower end of the transport plate is fixedly provided with a main abutment rod located outside the right end of the working cavity and abutable with the abutting concave rod, and the lower end of the transport plate is fixedly located in the working cavity and can be connected with the right side. The main adjusting lever abutted by the abutment block, a left end of the main adjusting lever is fixed with a connecting rod extending to the outside through the connecting port, and a lower end of the connecting rod is fixed with the outside and can be in contact with the abutting recess. A secondary abutting rod abutted by the rod, a lower end of the connecting rod is fixedly provided with a secondary adjusting rod which is disposed in the working cavity and can abut the abutting block.

6. The industrial perfume dosing machine according to claim 1, wherein the container replacement component comprises a horizontal bracket fixedly attached to the left end of the connection bracket, and the horizontal bracket is embedded with a motor, so that A motor shaft is dynamically connected to the lower end of the motor, a first coupling is fixed at the lower end of the motor shaft, a main gear shaft is rotatably connected to the replacement bracket, and an upper end of the main gear shaft is fixedly connected with the main shaft. The first coupling is cooperatively connected to the second coupling, the main gear shaft is fixed with a main gear located below the second coupling, and the replacement bracket is rotatably connected with the main gear. A secondary gear shaft on the left side of the gear shaft, a secondary gear fixedly engaged with the main gear is fixed on the secondary gear shaft, a main pulley is fixed on the upper end of the secondary gear shaft, and the horizontal support plate rotates A secondary pulley shaft is connected, a secondary pulley is fixed on the secondary pulley shaft, a belt is connected between the secondary pulley and the main pulley, and a secondary belt is fixed on the secondary pulley shaft. Matching gear on the upper side of the wheel, a position is fixed on the auxiliary pulley shaft The sector gear on the upper side of the mating gear can be meshed with the disc, and the teeth on the sector gear are symmetrical ninety degree teeth, and a replacement rack is slidably connected to the vertical bracket. The toothed surface of the replacement rack can be meshed with the sector gear, a spring spring is connected between the replacement rack and the left inner wall of the working cavity, and the disc is rotatably connected with the matching gear. The semi-circular swivel of the meshing connection is semi-circular.
